(19) United States
(12) Patent Application Publication
(10) Pub. No.: US 2006/0209560 A1
(43) Pub. Date: Sep. 21, 2006

(54) Light guide display device

(76) Inventor: Te-Hsiang Fang, Taipei Hsien (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 11/113,236

(22) Filed: Apr. 25, 2005

(30) Foreign Application Priority Data
Mar. 17, 2005 (TW) 094204113

(51) Int. Cl. F21V 5/00

(52) U.S. Cl. 362/579

(57) ABSTRACT

A light guide display device has a tubular hollow casing; a battery chamber for accommodating a battery and having an opening; a copper plate at the opening; a spring extended into the opening; the copper plate having a conductive wire at the copper plate; a fixed sheath in the fixed sheath housing having a space for passing the conductive wire and a light guide channel; a light guider disposed at the top of the light guide channel with patterns or texts at its backside; a display controller coupled to the conductive wire for selecting the emission of lights in different colors onto the light guide channel; a push button holder installed in the push button housing; and a push button latched into the push button and coupled to the display controller for starting and driving the display controller to emit lights of different colors.

### BACKGROUND OF THE INVENTION

1. Field of the Invention

The present invention relates to a light guide display device, and more specifically to a light guide having a pattern or a text such as a company logo or advertising figures at the backside of the light guide, and such patterns or texts can be replaced as needed.

2. Description of the Related Art

A prior art pen watch is a common device used in our daily life, and the pen watch provides users a stationery for writing as well as reading time. However, the prior art pen watch device usually has a time calculating function only and the company logo or advertising pattern is printed onto the pen body, so that the printed pattern is fixed and thus having the shortcoming of monotony.

In R.O.C. Utility Model No. M243368 entitled “Light guide device” and issued to the present inventor, a light guide device as shown in FIG. 4 comprises at least two light guiders 1 stacked one on top of the other, and at least one light guider 90 at the top has a groove 91 etched on the surface of the light guider 90, and the other light guider 90 is enclosed to forms a light guide channel 92. Since this patent adopts the foregoing structure, the light guide channel 92 inside the light guide device can be opened for putting different drawings or texts inside as needed, or the drawings or texts can be fixed onto the light guide channel 92 directly during its manufacture. It is not necessary to develop a new mold to obtain a plurality of variable lively patterns to satisfy different customer requirements. This patent uses a groove 91 etched on the surface of a light guider 90 and the light guide channel 92 formed by stacking and being sealed with another light guider 90, and then the texts or drawings are placed into the light guide channel 90. However, this prior art has the shortcomings of a complicated structure and a monotonous light emission.

### SUMMARY OF THE INVENTION

In view of the foregoing shortcomings of the prior art, the inventor of the present invention based on years of experience in the related field to conduct extensive researches and experiments to overcome the above shortcomings and finally invented the light guide device of the present invention.

It is a primary objective of the present invention to provide a light guide device having patterns or texts such as a company logo or advertising figures at the backside of the light guide and emits lights of various different colors.

Another objective of the present invention is to provide a light guide device having patterns or texts at the backside of the light guide and such patterns or texts can be replaced as needed.

To achieve the aforementioned objectives, the light guide device of the present invention comprises: a tubular hollow casing including an upper tube, a battery chamber, a fixed sheath housing, and a push button housing; a battery cover covered onto both sides of the battery chamber for accommodating a battery and having an opening; a copper plate installed on the external side of the opening, and a spring disposed at one side of the opening and extended into the opening, and the copper plate further includes a conductive wire disposed on the external side of the copper plate; a fixed sheath installed in the fixed sheath housing and having a space disposed at the bottom for passing the conductive wire and a light guide channel disposed at the top; a light guider installed in the fixed sheath housing and disposed at the top of the light guide channel and having patterns or texts etched at the backside of the light guide channel; a display controller installed in the push button housing and coupled to another side of the conductive wire for making a selection to emit lights of various different colors into the light guide channel; a push button holder installed in the push button housing; and a push button installed and latched into the push button housing, and disposed at an external side of the display controller and coupled to the display controller for starting and driving the display controller to emit lights of various different colors.

### BRIEF DESCRIPTION OF THE DRAWINGS

FIG. 1 is a schematic cross-sectional view of a light guide display device of the present invention;

FIGS. 2A to 2C are a cross-sectional view, a front view and a front view of a light guide of a preferred embodiment of the present invention respectively;

FIG. 3A to 3C are a cross-sectional view, a front view and a front view of a display controller of a preferred embodiment of the present invention respectively; and

FIG. 4 is a schematic view of a prior art light guide structure.

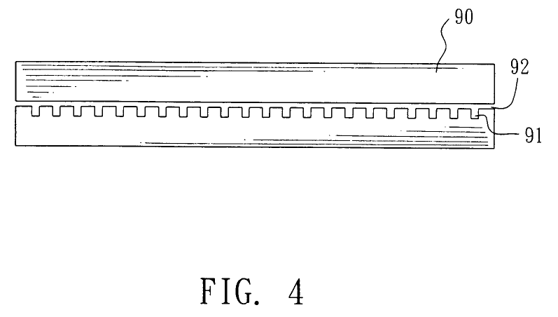

### DETAILED DESCRIPTION OF THE PREFERRED EMBODIMENTS

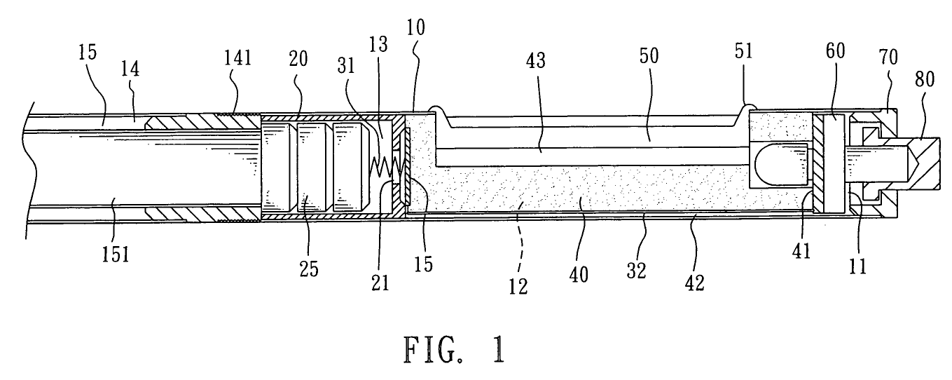

Referring to FIG. 1, a cross-sectional view of a light guide display device of the present invention is illustrated. In FIG. 1, the light guide display device comprises a casing 10, a battery cover 20, a copper plate 30, a fixed sheath 40, a light guider 50, a display controller 60, a push button holder 70, and a push button 80.

The casing 10 including but not limited to a tubular hollow casing made of a metal such as copper comprises a push button housing 11, a fixed sheath housing 12, a battery chamber 13, and an upper tube 14. The upper tube 15 further includes a thread 131 at an internal side of the upper tube 14 for coupling a lower tube 15, and the lower tube 15 includes a pen body 151 to define a pen.

The battery cover 20 is installed separately on both sides of the battery chamber 13 for accommodating a battery 25 and has an opening 21; wherein the battery 25 is preferably a button type battery and the quantity is preferably three pieces. The copper plate 30 is installed at an external side of the opening 21, and a spring 31 is fixed and extended into the opening 21 and in contact with the battery 25. The copper plate further comprises a conductive wire 32 disposed at an external side of the copper plate 30. The fixed sheath 40 has a stairway structure 41 disposed at one side and installed in the fixed sheath housing 12, a space 42 disposed at the bottom for passing the conductive wire 32, and a light guide channel 43 disposed at the top. The light guider 50 is installed in the fixed sheath housing 12 and disposed at the top of the light guide channel 43, and has patterns or texts including but not limited to a company logo or advertising slogan etched on the backside of the light guider 50. The light guider 50 has patterns or texts etched by a laser etching device onto the backside of the light guider 50 to give the feature of having various patterns with a small quantity. The light guider 50 further has a protrusion 51 slightly and outwardly extended from both sides of the light guider 50, such that the tension of the protrusion 51 can fix the light guider 50 to the fixed sheath housing 12, or a tool is used to apply a force on both ends of the protrusion 51 to remove the light guider 50.

The display controller 60 is installed in the push button housing 11 and coupled to another side of the conductive wire 32 for making a selection to emit lights of various different colors into the light guide channel 43, so that the light guider 50 can show a logo or advertising slogan with various different colors. Therefore, the present invention has improvements over the prior art pen watch or light guide device.

The push button holder 70 is installed in the push button housing 11 for accommodating and holding the push button 80. The push button 80 is installed and fixed into the push button holder 70, which is disposed at an external side of the display controller 60 and coupled to the display controller 60 for starting the display controller 60 and driving the display controller 60 to emit lights of various different colors.

In an application, a user just needs to push the push button 80 to move the push button 80 towards the display controller 60 and electrically connect the display controller to emit lights of various different colors into the light guide channel 43.

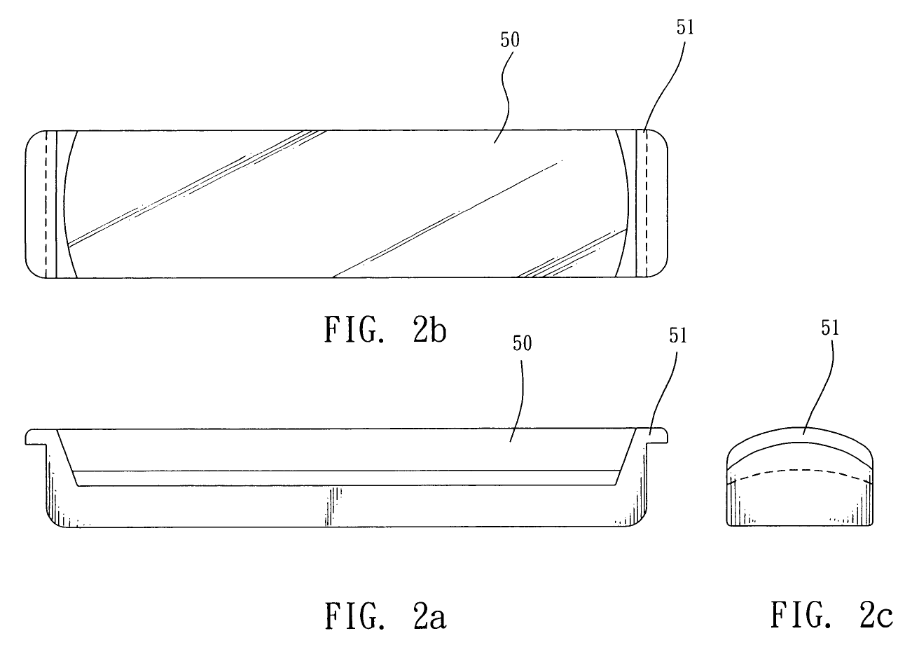

Referring to FIGS. 2A to 2C, cross-sectional views of a light guider 50 according to a preferred embodiment of the present invention are illustrated. In the figures, the light guider 50 has patterns or texts including but not limited to a company logo or advertising slogan etched on the backside of the light guider 50. With a laser etching device, various patterns in a small quantity can be provided. Further, the light guider 50 has a protrusion 51 slightly and outwardly extended from both ends of the light guider 50, and the tension of the protrusion 51 can hold the light guider 50 into the fixed sheath housing 12 or a tool is used to apply a force onto both ends of the protrusion 51 to remove the light guider 50.

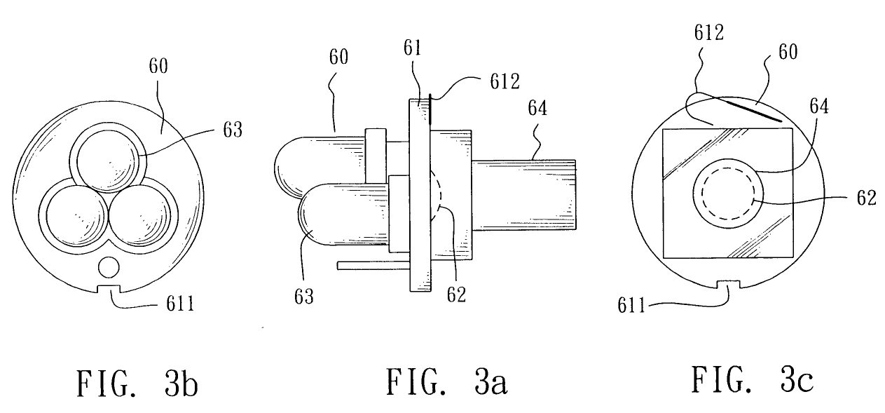

Referring to FIGS. 3A to 3C, a cross-sectional view, a front view and a back view of a display controller 60 of a preferred embodiment of the present invention are illustrated. In the figures, the display controller 60 further comprises a printed circuit board 161, a controller 62, a display device 63 and a push button 64.

The printed circuit board 61 is accommodated in the push button housing 11 and is substantially circular in shape. The printed circuit board 61 has an opening 611 for combining the stairway structure 41 of the fixed sheath 40. In addition, one end of the printed circuit board 61 has an anode spring 612 with an end coupled to the printed circuit board 61 and another end being protruded from the external side of the printed circuit board 61 to facilitate the contact with the housing 10 and define an electrically connected circuit. The controller 62 is installed on the printed circuit board 61 for controlling the display device 63. The display device 63 is installed on the printed circuit board 61 for receiving the control of the controller 62 to emit lights of various different colors. The display device 63 is preferably a light emitting diode (LED) and has a quantity of three pieces, and these three LEDs are installed with an interval 120′ apart and respectively have the three primary colors: red, blue and green, so as to produce various different colors by mixing the three primary colors according to the control of the controller 62. The push button 64 is installed on the printed circuit board 61, disposed on another side of the display device 63, coupled to the controller 62, and sheathed into the push button 80, such that if a user presses the push button to electrically connect the circuit, the controller 62 controls the display device 63 to emit lights.

The push button 64 could be a multi-sectional push button including but not limited to an 8-section push button. If a user presses the push button 64 once, the controller 62 drives the display device 63 to emit a light including but not limited to a red light. If the user presses the push button 64 twice, the controller 62 drives the display device 63 to emit a light including but not limited to a blue light. If the user presses the push button 64 for three times, the controller 62 drives the display device 63 to emit a light including but not limited to a green light. If the user presses the push button 64 for four times, the controller 62 drives the display device 63 to emit a light including but not limited to a mixed red and blue light. If the user presses the push button 64 for eight times, the controller 62 drives the display device 63 to emit a light including but not limited to a mixed red, blue and green light. Therefore, the control of the push button 64 can drive the display device 63 to emit various different colors into the light guide channel 43, such that the light guider 50 can show a company logo or an advertising slogan of various different colors.

With the present invention, a pattern or a text such as a company logo or an advertising pattern is etched on the backside of the light guider, and the light guide display device can be replaced as needed, and thus the shortcomings of a prior art pen watch or light guide device are overcome.

In summation of the above description, the present invention herein complies with the patent application requirements and is submitted for patent application. However, the description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light guide display device, comprising:
a casing, including an upper tube, a battery chamber, a fixed sheath housing and a push button housing;
a battery cover, covered onto both sides of said battery chamber for accommodating said battery and having an opening;
a copper plate, installed at an external side of said opening and having a spring extended into said opening, and a conductive wire disposed at an external side of said copper plate;
a fixed sheath, installed in said fixed sheath housing, and having a space disposed at the bottom for passing said conductive wire and a light guide channel;
a light guider, installed in said fixed sheath housing and disposed at the top of said light guide channel and having a pattern or a text etched onto its backside;
a display controller, installed in said push button housing and coupled to another side of said conductive wire for making a selection to emit lights of various different colors into said light guide channel;
a push button holder, installed in said push button housing; and
a push button, installed and latched into said push button holder and disposed at an external side of said display controller and coupled to said display controller for starting said display controller and driving said display controller for emitting lights of various different colors.

2. The light guide display device of claim 1, wherein said tubular hollow casing is made of a metal which is preferably copper.

3. The light guide display device of claim 1, wherein said upper tube includes a thread at its internal side for coupling a lower tube, and said lower tube further comprises a pen body to define a pen.

4. The light guide display device of claim 1, wherein said battery is preferably a button type battery and has a quantity of three pieces.

5. The light guide display device of claim 1, wherein said light guider comprises a protrusion separately and slightly extended from both sides of said light guider, such that the stress of said protrusion holds or moves said light guider in said fixed sheath housing.

6. The light guide display device of claim 1, wherein said light guider has a pattern or a text disposed at the backside of said light guider, and said pattern or text is etched by a laser etching device.

7. The light guide display device of claim 1, wherein said fixed sheath has a stairway structure at one side.

8. The light guide display device of claim 7, wherein said display controller further comprises:
a printed circuit board, disposed in said push button housing, and having an opening for coupling said stairway structure;
a controller, installed on said printed circuit board for receiving a control of said controller to emit lights of different colors; and
a push button, installed on said printed circuit board and disposed on another side of said display device and coupled to said controller, such that said push button is sheathed into said push button housing and a user presses said push button for an electric connection to control said controller and drive said display device to emit a light.

9. The light guide display device of claim 8, wherein said display device is preferably a light emitting diode and has a quantity of three pieces, and said light emitting diodes are disposed with an interval apart, and have the color of three primary colors including red, blue and green, so as to produce various different colors by mixing said three primary colors.

10. The light guide display device of claim 1, wherein said printed circuit board further comprises an anode spring with an end coupled to said printed circuit board and another end being protruded from an external side of said printed circuit board for facilitating a contact with said hollow casing.

11. The light guide display device of claim 1, wherein said casing is a tubular hollow casing.

12. The light guide display device of claim 1, wherein said push button is a multi-sectional push button and preferably an 8-section push button; such that if a user presses said push button once, then said controller drives said display device to emit a red light; if a user presses said push button twice, then said controller drives said display device to emit a blue light; if a user presses said push button for three times, then said controller drives said display device to emit a green light; if a user presses said push button for four times, then said controller drives said display device to emit a mixed red and blue light; and if a user presses said push button for eight times, then said controller drives said display device to emit a mixed red, blue and green light; such that a control of said push button can drive said display device to emit lights of various different colors into said light guide channel and said light guider shows a company logo or an advertising text of various different colors.
